(19) United States
(12) Patent Application Publication
(10) Pub. No.: US 2021/0405159 A1
(43) Pub. Date: Dec. 30, 2021

(54) VEHICLE AND SIDE-REARVIEW MIRROR FOR MOUNTING AT VEHICLE

(71) Applicant: SZ DJI TECHNOLOGY CO., LTD., Shenzhen (CN)

(72) Inventors: Yilun HUANG, Shenzhen (CN); Yongsheng ZHANG, Shenzhen (CN); Zhongqin ZHOU, Shenzhen (CN)

(21) Appl. No.: 17/468,915

(22) Filed: Sep. 8, 2021

Related U.S. Application Data
(63) Continuation of application No. PCT/CN2019/077495, filed on Mar. 8, 2019.

(51) Int. Cl. G01S 7/481; G01S 17/931; B60R 1/12

(52) U.S. Cl. CPC G01S 7/4813; B60R 2001/1223; B60R 1/12; G01S 17/931

(57) ABSTRACT

A side-rearview mirror includes a sensor and a housing with a cavity. The sensor includes a LIDAR accommodated in the cavity and configured to detect environment information of one side of a vehicle. One side of the side-rearview mirror facing a side-rear direction of the vehicle includes a non-mirror surface.

### CROSS-REFERENCE TO RELATED APPLICATION

This application is a continuation of International Application No. PCT/CN2019/077495, filed Mar. 8, 2019, the entire content of which is incorporated herein by reference.

### TECHNICAL FIELD

The present disclosure relates to the technical field of autonomous driving and, more particularly, to a vehicle and a side-rearview mirror for mounting at the vehicle.

### BACKGROUND

A self-driving car can realize 360-degree perception of surrounding environment through multiple sensors, and perform autonomous navigation to lead passengers to their destinations. Many companies are now designing their own autonomous driving systems, in which selection and location design of different types of sensors have significant impact on modules such as calibration of the multiple sensors, environmental perception, control decision, etc. A good autonomous driving sensor system should meet the following conditions: 1) realizing 360-degree perception of the surrounding environment without blind spots; 2) providing reliable and stable environmental perception data with little redundancy; 3) performing sensor calibration conveniently and quickly, and meeting needs of real-time calibration result verification.

With continuous upgrade of autonomous driving, more environment sensors will be mounted at future vehicles. Arrangement of a sensor at the vehicle needs to meet requirements of sensor accuracy and stability, and should avoid affecting vehicle appearance style as much as possible.

Most existing autonomous driving sensors are arranged externally, and the sensors are arranged through vehicle roof structural members or by remodeling vehicle bodies, so that structure is complex, remodeling workload is large, and the vehicle appearance style is affected. Also, an external sensor arrangement scheme cannot realize quick disassembly, assembly, maintenance, and replacement.

### SUMMARY

In accordance with the disclosure, there is provided a side-rearview mirror including a sensor and a housing with a cavity. The sensor includes a LIDAR accommodated in the cavity and configured to detect environment information of one side of a vehicle. One side of the side-rearview mirror facing a side-rear direction of the vehicle includes a non-mirror surface.

### BRIEF DESCRIPTION OF THE DRAWINGS

In order to explain the technical solutions in the embodiments of the present disclosure more clearly, accompanying drawings used in the description of the embodiments are briefly described. Obviously, the drawings in the following description are some embodiments of the present disclosure, and other drawings can be obtained from these drawings without any inventive effort for those of ordinary skill in the art.

FIG. 1 is a schematic diagram showing arrangement of a side-rearview mirror for mounting at a vehicle according to an embodiment of the present disclosure.

FIG. 2 is a schematic simulation diagram showing detection range of a LIDAR in a side-rearview mirror of FIG. 1.

FIG. 3 is a schematic diagram showing an overall structure of a side-rearview mirror according to an embodiment of the present disclosure.

FIG. 4 is a schematic structural diagram of a housing upper cover of a side-rearview mirror according to an embodiment of the present disclosure.

FIG. 5 is a schematic structural diagram of a housing middle frame of a side-rearview mirror according to an embodiment of the present disclosure.

FIG. 6A is a top view of a support structure of a side-rearview mirror according to an embodiment of the present disclosure.

FIG. 6B is a side view of a support structure of a side-rearview mirror according to an embodiment of the present disclosure.

FIG. 7 is a schematic structural diagram of a housing lower cover of a side-rearview mirror according to an embodiment of the present disclosure.

FIG. 8 is a schematic diagram showing an overall structure of a second housing of a side-rearview mirror according to an embodiment of the present disclosure.

FIG. 9 is a schematic structural diagram of a vision sensor of a side-rearview mirror according to an embodiment of the present disclosure.

FIG. 10 is a schematic structural diagram of an appearance structure of a side-rearview mirror according to an embodiment of the present disclosure.

FIG. 11 is a schematic structural diagram of a fixation structure of a side-rearview mirror according to an embodiment of the present disclosure.

FIG. 12 is a schematic structural diagram showing a LIDAR being mounted at a LIDAR base in a side-rearview mirror according to an embodiment of the present disclosure.

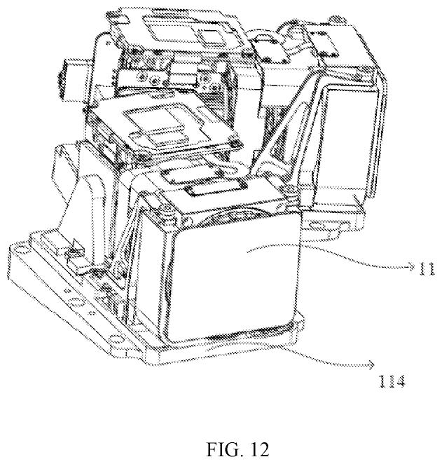

### REFERENCE NUMERALS

Side-rearview mirror 10;
LIDAR 11;
Vision sensor 12;
Housing upper cover 102;
First housing upper cover 1021;
Housing middle frame 103;
First housing middle frame 1031;
Housing lower cover 104;
First housing lower cover 1041;
Window 105;
Heat dissipation structure 106;
First housing 107;
Second housing 108;
Support structure 109;
Reinforcement structure 111;
Fixation structure 112;
Appearance structure 113;
LIDAR base 114.

### DETAILED DESCRIPTION OF THE EMBODIMENTS

In order to make the objectives, technical solutions, and advantages of the present disclosure more obvious, exemplary embodiments according to the present disclosure will be described in detail below with reference to the accompanying drawings. Obviously, the described embodiments are some of rather than all the embodiments of the present disclosure. It should be noted that the present disclosure is not limited by the exemplary embodiments described herein. Based on the embodiments of the present disclosure described in the present disclosure, all other embodiments obtained by those of ordinary skill in the art without inventive effort shall fall within the scope of the present disclosure.

In the following description, a lot of specific details are given in order to provide a more thorough understanding of the present disclosure. However, it is obvious to those skilled in the art that the present disclosure can be implemented without one or more of these details. In some other examples, some technical features known in the art are not described in order to avoid confusion with the present disclosure.

It should be noted that the present disclosure can be implemented in different forms and should not be construed as being limited to the embodiments described here. Rather, these embodiments are provided so that the disclosure will be thorough and complete, and the scope of the present disclosure will be fully conveyed to those skilled in the art.

The terms used herein is for the purpose of describing specific embodiments only and is not as a limitation of the present disclosure. As used herein, the singular forms of “a,” “an,” and “the” are intended to include plural forms as well, unless the context clearly indicates otherwise. It should also be understood that the terms “comprising,” and/or “including”, when used in this specification, determine the existence of the described features, integers, steps, operations, elements and/or components, but do not exclude the existence or addition of one or more other features, integers, steps, operations, elements, components, and/or groups. As used herein, the term “and/or” includes any and all combinations of related listed items.

In order to provide a thorough understanding of the present disclosure, detailed steps and detailed structures will be presented in the following description to explain the technical solutions of the present disclosure. Some embodiments of the present disclosure are described in detail as follows. However, in addition to these detailed descriptions, the present disclosure may also have other embodiments.

In order to solve the above problems, the present disclosure provides a side-rearview mirror for mounting at a vehicle, which includes a LIDAR, a vision sensor, and a housing. The LIDAR is configured to detect environment information at one side of the vehicle, and the vision sensor is configured to obtain an environment image at one side of the vehicle. The housing has a cavity formed therein, and the LIDAR and the vision sensor are accommodated in the cavity.

Or the side-rearview mirror includes a LIDAR and a housing, where the LIDAR is configured to detect the environment information at one side of the vehicle. The housing has a cavity formed therein, and the LIDAR is accommodated in the cavity. Also, one side of the side-rearview mirror facing a side-rear direction of the vehicle is a non-mirror surface.

The present disclosure improves the side-rearview mirror of the vehicle, and integrates the LIDAR, or the LIDAR and vision camera into a redesigned side-rearview mirror structure. The structure and arrangement are optimized while ensuring that use requirements of sensor can be met, so that the entire sensor is more integrated, smaller in volume, and has less impact on appearance of the vehicle. With such improvement, the side-rearview mirror has a high degree of integration, compact structure, and reasonable arrangement, which solves the problems of complex structure, large volume, and impact on appearance of conventional arrangement of current autonomous vehicles. Multiple sensors are integrated into one side-rearview mirror, so that the whole side-rearview mirror can be quickly mounted, removed, and maintained, and a protection effect on the sensors can be achieved.

Hereinafter, the side-rearview mirror for mounting at the vehicle in the present disclosure will be described in detail with reference to the accompanying drawings. In the case of no conflict, the following embodiments and features in the embodiments can be combined with each other.

The side-rearview mirror for mounting at the vehicle is configured to sense surrounding environment of the vehicle, for example, to collect vehicle information and surrounding environment information, where the surrounding environment information includes image information and three-dimensional coordinate information of the surrounding environment. It should be noted that, in addition to being mounted at the vehicle, the side-rearview mirror can also be applied to other mobile platforms for detecting environment in a rear-side direction.

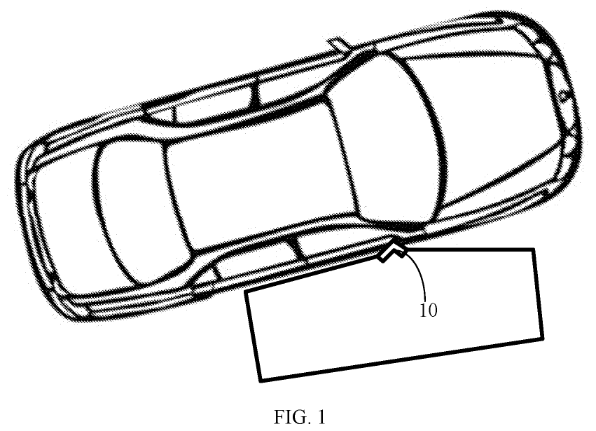

In FIG. 1, for better explanation and description of position of the side-rearview mirror, a side-rearview mirror 10 is shown only in form of an L-shaped structure. It should be understood that the figure is for illustration only and does not limit shape of the side-rearview mirror, and the side-rearview mirror can also have a shape similar to a common rearview mirror, or other shapes.

In the present disclosure, the side-rearview mirror is arranged in a region and position where a rearview mirror is conventionally placed at the vehicle, for example, the side-rearview mirror is usually arranged at a side of a front part of the vehicle, for directly obtaining the surrounding environment information in a rear side, a left/right side, a lower side, etc. of the vehicle.

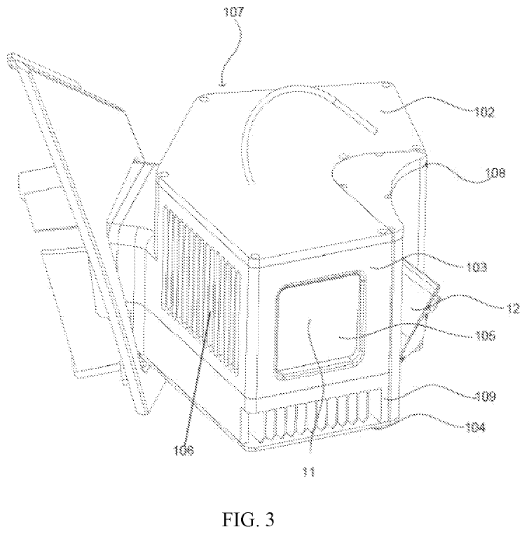

In some embodiments, as shown in FIG. 3, the side-rearview mirror for mounting at the vehicle in the present disclosure includes a LIDAR 11, a vision sensor 12, and a housing. The LIDAR 11 is configured to detect the environment information at one side of the vehicle, and the vision sensor 12 is configured to obtain the environment image at one side of the vehicle. The housing has a cavity formed therein, and the LIDAR 11 and the vision sensor 12 are accommodated in the cavity, as shown in FIG. 3.

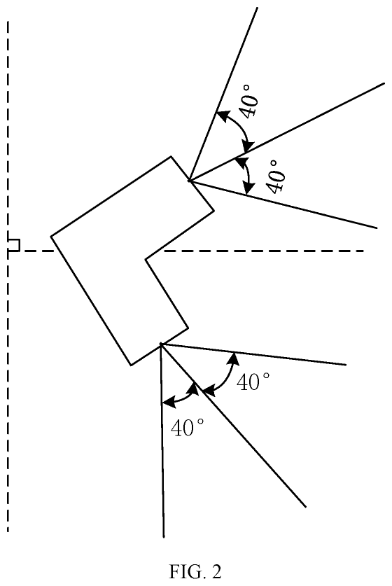

Mounting position of the side-rearview mirror is at a position closer to the front side of the vehicle, preferentially meeting a viewing angle coverage of the rear-side direction. Mounting angle and field of view angle of the side-rearview mirror are shown in FIG. 2.

In some embodiments of the present disclosure, the LIDAR at least includes a first LIDAR and a second LIDAR integrated within the housing, and field of view angles of the first LIDAR and the second LIDAR at least partially overlap, so as to ensure that there is no detection blind spot between the first LIDAR and the second LIDAR.

In some embodiments, the field of view angles of the first LIDAR and the second LIDAR are overlapped as little as possible, so as to increase a range of a total field of view angle after the first LIDAR and the second LIDAR are combined.

For example, an overlap range of the field of view angles of the first LIDAR and the second LIDAR is less than 10°, and more specifically, in some embodiments of the present disclosure, the overlap range of the field of view angles of the first LIDAR and the second LIDAR is 5°.

Positional relationship between the first LIDAR and the second LIDAR can be set according to actual needs, for example, according to a key area and direction for detection. In some embodiments of the present disclosure, the first LIDAR and the second LIDAR are arranged such that their optical axes are perpendicular to each other. As shown in FIG. 2, transmission and reception elements of the first LIDAR and the second LIDAR are facing outside of the vehicle.

Correspondingly, the side-rearview mirror also includes a LIDAR base 114 configured to fix and mount the LIDAR, and the LIDAR base 114 is fixed at a support structure.

Further, in some embodiments of the present disclosure, the LIDAR base 114 includes a bottom housing for placing the LIDAR, and the LIDAR is fixed by being clamped in the bottom housing of the LIDAR base 114. In some other embodiments, the LIDAR and the LIDAR base 114 may also include other fixation structures, such as bolts and nuts.

In some embodiments, arrangement of the LIDAR base 114 matches arrangement of the LIDAR, for example, two bottom housings of the LIDAR base where two LIDARs are mounted are also perpendicular to each other.

After the first LIDAR and the second LIDAR are fixedly mounted, a combined field of view angle of the first LIDAR and the second LIDAR is greater than or equal to 155°.

The field of view angle of the first LIDAR is greater than or equal to 80°, and/or the field of view angle of the second LIDAR is greater than or equal to 80°.

In some embodiments of the present disclosure, as shown in FIG. 2, the field of view angle of the first LIDAR is equal to 80°, and the field of view angle of the second LIDAR is equal to 80°. The overlap range of the field of view angles of the first LIDAR and the second LIDAR is 5° after they are combined, and the total field of view angle obtained is equal to 155°. FIG. 2 is only a schematic diagram showing the positional relationship and angles of the first LIDAR and the second LIDAR.

Further, a boundary of the field of view angle of any one of the first LIDAR and the second LIDAR is parallel to an extension direction of a vehicle body. For example, the boundary of the field of view angle of one of the first LIDAR and the second LIDAR that is closer to the rear side of the vehicle body is parallel to the extension direction of the vehicle body, as shown in FIG. 2.

After being mounted at the LIDAR base, the LIDAR is accommodated in the cavity formed by the housing, and the housing and arrangement of the LIDAR and the vision sensor in the cavity will be respectively described below.

FIG. 3 is a schematic diagram showing an overall structure of the housing. In this figure, the housing includes a first housing 107 and a second housing 108, where the first housing forms a first cavity to accommodate the LIDAR, and the second housing forms a second cavity to accommodate the vision sensor.

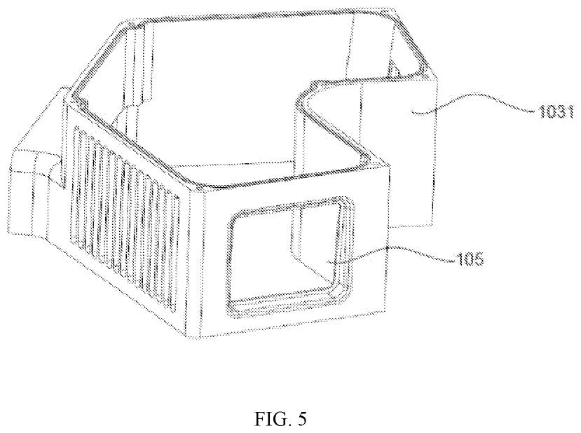

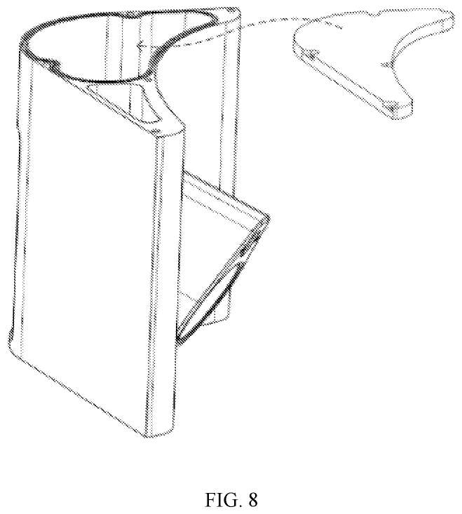

FIG. 5 shows a structure of a part of the first housing 107, and FIG. 8 shows a structure of a part of the second housing 108.

An opening is provided at a side wall of one side of the second housing in contact with the first housing. The opening is configured to introduce a power connection structure for connecting the vision sensor with an external power source into the first housing 107, and to pull the second housing 108 to tightly attach to the first housing 107 by fixing the power connection structure, thereby fixing the second housing 108. In some other embodiments, other connection structures for fixing can also be provided between the first housing 107 and the second housing 108, which will not be repeated herein.

A plurality of windows 105 are provided at both the first housing and the second housing, which are configured to reveal the LIDAR and the vision sensor.

Specifically, shape of the window 105 matches shape of the sensor to be exposed. For example, as shown in FIG. 3, a square window is provided at the first housing 107, so as to reveal transmission and/or reception elements of the LIDAR, such as transmission and/or reception lenses, while the window is arranged in a circular shape in the second housing, so as to reveal fisheye lens in the visual sensor. It should be noted that, in addition to the square and circular shapes described above, the window can also be triangular, polygonal, approximately circular, etc., and the shape is matched to the shape of the LIDAR and the vision sensor as much as possible, so as to minimize a gap between the two, thereby protecting the LIDAR and the visual sensor.

In order to further prevent water vapor, dust, particles, etc. from entering the housing, the window needs to be further sealed, for example, a sealing structure is also provided at the window to seal a gap between the LIDAR and the vision sensor and a housing middle frame, which further protects the LIDAR and the visual sensor.

The sealing structure can be a commonly used sealing material, for example, a sealant or a sealing strip can be used to fill the gap between the LIDAR and the vision sensor and the housing middle frame.

The housing includes a housing upper cover 102, a housing lower cover 104, and a housing middle frame 103 arranged at an edge position between the housing upper cover 102 and the housing lower cover 104 to enclose the cavity.

More specifically, after the housing upper cover 102, the housing lower cover 104, and the housing middle frame 103 enclose the cavity, a partition is provided between the housing upper cover 102 and the housing lower cover 104, so that the cavity is divided into the first cavity and the second cavity that are independent of each other.

In some other embodiments, the first housing and the second housing each include the housing upper cover 102, the housing lower cover 104, and the housing middle frame 103. After the first cavity and the second cavity independent of each other are each enclosed, the first housing and the second housing are detachably assembled into one body.

The first housing and the second housing will be described in detail below.

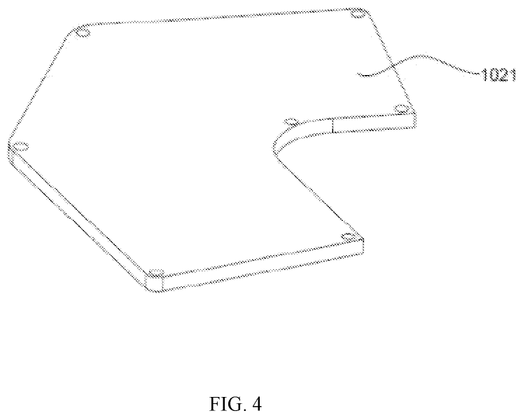

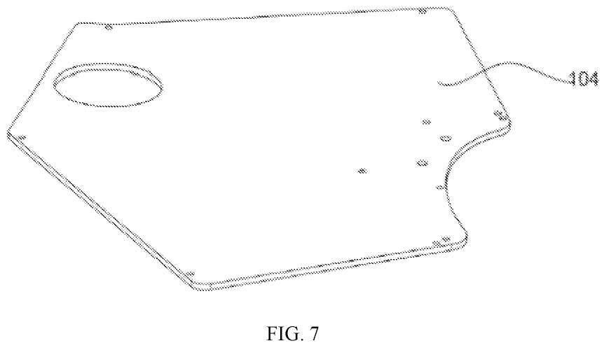

The first housing includes a first housing upper cover 1021, a first housing lower cover 1041, and a first housing middle frame 1031. FIG. 4 is a schematic structural diagram of the first housing upper cover in the side-rearview mirror according to an embodiment of the present disclosure. FIG. 5 is a schematic structural diagram of the first housing middle frame in the side-rearview mirror according to an embodiment of the present disclosure. FIG. 7 is a schematic structural diagram of the first housing lower cover in the side-rearview mirror according to an embodiment of the present disclosure.

As shown in FIG. 4, the housing upper cover 102 is a flat structure whose shape matches the shape of the LIDAR that needs to be accommodated, so that the side-rearview mirror is more compact and saves space.

The housing upper cover is also provided with other structures, such as connection holes, etc.

As shown in FIG. 4, the first housing middle frame 1031 encloses a body profile of the first housing.

The window configured to reveal the LIDAR is arranged in the first housing middle frame 1031.

Further, a top surface and a bottom surface of the first housing middle frame 1031 are respectively provided with connection holes, such as screw holes, through which the first housing middle frame 1031 is fixedly connected to the first housing upper cover 1021 and the first housing lower cover 1041.

In some embodiments, in order to better dissipate heat from the LIDAR, a grid structure is also provided at a side wall of the first housing middle frame 1031 to accelerate heat dissipation generated by the LIDAR. The grid structure can also be used as reinforcement ribs to improve strength of the first housing middle frame 1031, so as to increase its pressure bearing capacity.

The grid structure can be a plurality of protrusions regularly arranged at the side wall of the first housing middle frame 1031, for example, a plurality of mutually parallel protruding strips are arranged at the side wall of the first housing middle frame 1031 from top to bottom, where the protruding strips can be cylindrical or plate-shaped, and are not limited to one.

As shown in FIG. 7, the first housing lower cover 1041 is a flat structure whose shape matches the shape of the LIDAR that needs to be accommodated, so that the side-rearview mirror is more compact and saves space.

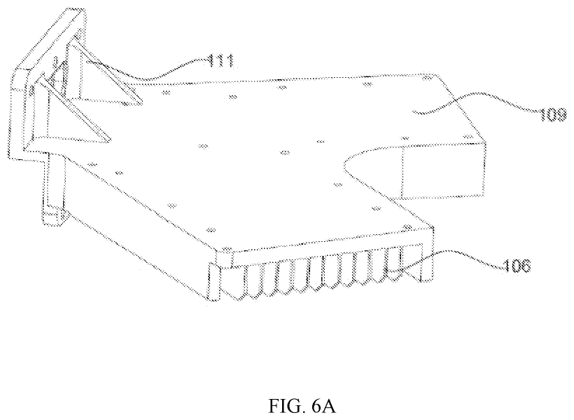

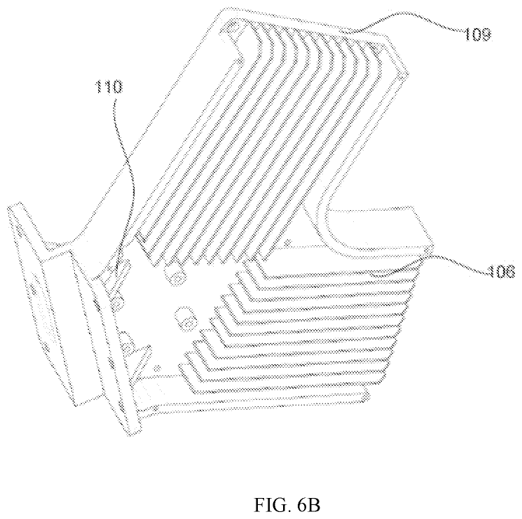

Further, a support structure 109 for supporting the LIDAR is also provided above the first housing lower cover 1041, as shown in FIGS. 6A and 6B. The support structure 109 includes a flat plate part located at the housing lower cover and a connection plate connected with the vehicle, and a plurality of reinforcement structures 111 are provided at the connection plate.

Specifically, the flat plate part is arranged in parallel or substantially parallel to the first housing lower cover 1041 and the first housing upper cover 1021 with the same shape.

Further, the connection plate is arranged at an end away from the connection of the second housing, as shown in FIG. 6A. The connection plate and the flat plate part are arranged perpendicular to each other. In some embodiments, the flat plate part is arranged in a horizontal direction, and the connection plate is arranged in a vertical direction.

Length of the connection plate in the vertical direction is greater than thickness of the flat plate part so as to protrude from upper and lower surfaces of the flat plate part.

A mounting structure is also arranged at the side wall of the first housing middle frame 1031 close to the vehicle. The mounting structure includes a notch arranged at bottom of the side wall, and a protrusion protruding from a surface of the side wall is arranged at the notch. Bottom of the mounting structure is not provided with the protrusion, but is also a notch, as shown in FIG. 5.

When the support structure is arranged between the first housing lower cover 1041 and the first housing middle frame 1031, a part of the connection plate located above the flat plate part enters the mounting structure and is covered by the mounting structure.

Further, as shown in FIG. 6A, the reinforcement structure 111 includes a rib plate to increase strength of the support structure, and two side surfaces of the rib plate are respectively connected with the flat plate part and the connection plate.

The rib plate is a triangle, as shown in FIG. 6A, and two sides of the triangle are respectively connected with the flat plate part and the connection plate.

Further, the reinforcement structure 111 is arranged at a side wall of the connection plate proximal to the cavity, and the reinforcement structure 111 is arranged at side walls of the connection plate at upper and lower ends of the flat plate part, as shown in FIG. 6B.

Further, a heat dissipation structure 106 is provided at a surface of the support structure close to the housing lower cover for heat dissipation and cooling of the sensor.

In some embodiments, the heat dissipation structure 106 includes a heat sink and/or a fan.

In some embodiments of the present disclosure, the heat dissipation structure 106 is a heat dissipation plate with a plate structure, and an extension direction of the plate structure is perpendicular to an extension direction of the flat plate part.

Further, the LIDAR base is fixed at the support structure.

The second housing will be described in detail below. Second housing can be arranged in a manner similar to that for the first housing, for example, the second housing includes a second housing upper cover, a second housing lower cover, and a second housing middle frame to enclose the second cavity.

In some other embodiments of the present disclosure, other parts of the second housing than the second housing upper cover may be integrally formed, as shown in FIG. 8. Other parts than the housing are integrally formed by, for example, an injection molding process, to form the second cavity for accommodating the vision sensor.

The window at the second housing may be a window protruding from a surface of the second cavity to accommodate a camera lens in the vision sensor.

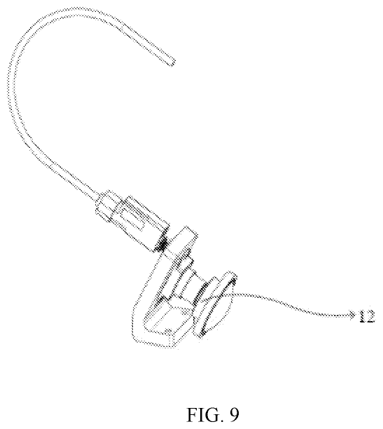

The vision sensor 12 includes a camera, as shown in FIG. 9, and the camera is arranged in an independent accommodation space within the housing that is separate from the first LIDAR and the second LIDAR.

The camera may have a fisheye lens, which is a lens with a focal length of 16 mm or less and a viewing angle close to or equal to 180°, and is a wide-angle lens. In order to reach a maximum photographing viewing angle of the lens, the lens of the camera protrudes to the front and is exposed through the window at the second housing.

In some embodiments, the vision sensor also includes an image display element arranged outside the housing, which is communicatively connected with the camera and is configured to display the environment image obtained by the camera.

In some embodiments, the side-rearview mirror also includes a cleaning structure, which is arranged at a periphery of the camera and is configured to detect and/or clean the camera.

In some embodiments, the cleaning structure includes a cleaning nozzle and a pipe to clean the camera, and the pipe is configured to connect to a vehicle water tank.

For example, in some embodiments, the pipe is connected to the vehicle water tank that cleans a front windshield.

In some embodiments, the cleaning structure also includes a detection element configured to detect cleanliness of the camera, determine whether cleaning is required according to detection result, and trigger the cleaning nozzle if cleaning is required.

The vision sensor 12 also includes the power connection structure which is a U-shaped structure as shown in FIG. 9, and the U-shaped structure is partially inserted in the first housing.

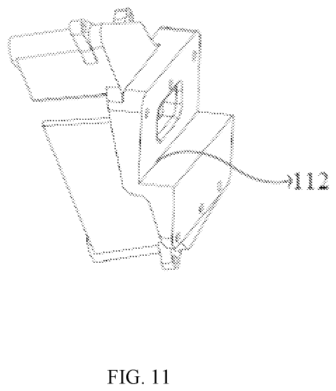

The manner in which the side-rearview mirror is mounted at the vehicle will be described in detail below. As shown in FIG. 11, in some embodiments of the disclosure, the side-rearview mirror is mounted at the vehicle as a whole through a fixation structure 112.

The fixation structure 112 includes a first surface and a second surface arranged oppositely, where the first surface is configured to be fixedly mounted at the vehicle, and the second surface is configured to mount the housing.

A fixation connection member is provided at the first surface of the fixation structure, which is configured to connect with a matching fixation connection member at the vehicle. When the two are fixedly connected, the side-rearview mirror is fixed at the vehicle. The fixation connection member may be a bolt or a nut, and the matching fixation connection member may correspondingly a nut or a bolt. In some other embodiments, the fixation connection member and the matching fixation connection member may also be another matching structure that can be used for fixation, such as a slot structure, etc.

In some embodiments, a mounting shaft is provided at the housing, and a mounting shaft hole is provided at the second surface, where the housing is sleeved and fixedly mounted in the mounting shaft hole via the mounting shaft.

In some embodiments of the present disclosure, as shown in FIG. 11, a nut is arranged at the first surface, and a connection structure corresponding to the support structure in the second housing and the housing middle frame is arranged at the second surface, so that the housing is fixedly mounted at the fixation structure through the support structure and the housing middle frame, and is mounted at the vehicle through the first surface.

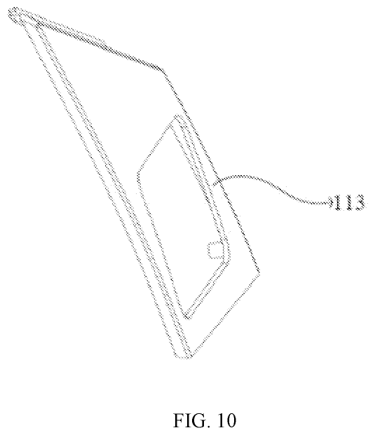

In some embodiments, as shown in FIG. 10, an appearance structure 113 with the same color as vehicle color is sleeved on the second surface of the fixation structure, so that the appearance is more attractive.

In some other embodiments of the present disclosure, the side-rearview mirror includes the sensor and the housing, where the sensor includes the LIDAR configured to detect the environment information at one side of the vehicle. The housing has the cavity formed therein, and the LIDAR is accommodated in the cavity. Also, one side of the side-rearview mirror facing the side-rear direction of the vehicle is a non-mirror surface.

It should be understood that one side of the side-rearview mirror facing the side-rear direction of the vehicle is a non-mirror surface, which may be that the side-rearview mirror does not include a reflective mirror surface. The side-rearview mirror only obtains the environment information around the vehicle through the sensor rather than the reflective mirror surface.

For both the LIDAR and the housing, reference can be made to related description in the foregoing embodiments. Also, the sensor in the side-rearview mirror may also include the vision sensor, and for which, reference can be made to related description in the foregoing embodiments.

The present disclosure improves the side-rearview mirror of the vehicle, and integrates the LIDAR, or the LIDAR and vision camera into a redesigned side-rearview mirror structure. The structure and arrangement are optimized while ensuring that use requirements of sensor can be met, so that the entire sensor is more integrated, smaller in volume, and has less impact on appearance of the vehicle. With such improvement, the side-rearview mirror has a high degree of integration, compact structure, and reasonable arrangement, which solves the problems of complex structure, large volume, and impact on appearance of conventional arrangement of current autonomous vehicles. Multiple sensors are integrated into one side-rearview mirror, so that the whole side-rearview mirror can be quickly assembled, disassembled, and maintained, and a protection effect on the sensors can be achieved.

Although the exemplary embodiments have been described herein with reference to the accompanying drawings, it should be understood that the exemplary embodiments described above are merely exemplary, and are not intended to limit the scope of the present disclosure thereto. Those of ordinary skill in the art can make various changes and modifications therein without departing from the scope and spirit of the present disclosure. All these changes and modifications are intended to be included within the scope of the present disclosure as claimed in the appended claims.

Those of ordinary skill in the art may realize that the units and algorithm steps of the examples described in the embodiments disclosed herein can be implemented by electronic hardware or a combination of computer software and electronic hardware. Whether these functions are executed by hardware or software depends on the specific application and design constraints of the technical solutions. Professionals and technicians can use different methods for each specific application to implement the described functions, but such implementation should not be considered beyond the scope of the present disclosure.

It should be understood that, in some embodiments provided by the present disclosure, the disclosed device and method can be implemented in other manners. For example, the example device described above is only illustrative. For example, the division of the modules or units is only a logical function division, and there may be other divisions in actual implementation, e.g., multiple units or components may be combined or integrated into another device, or some features may be omitted or not performed.

In the specification provided here, a lot of specific details are described. However, it can be understood that the embodiments of the present disclosure can be implemented without these specific details. In some embodiments, well-known methods, structures, and technologies are not shown in detail, so as not to obscure the understanding of this specification.

Similarly, it should be understood that in order to simplify the present disclosure and help the understanding of one or more of the various aspects of the disclosure, the various features of the present disclosure are sometimes grouped together into a single embodiment, figure, or description thereof in the description of the exemplary embodiments of the present disclosure. However, the method of the present disclosure should not be construed as reflecting the intention that the claimed disclosure requires more features than those explicitly stated in each claim. More precisely, as reflected in the corresponding claims, the point of the disclosure is that the corresponding technical problems can be solved with features that are less than all the features of a single disclosed embodiment. Therefore, the claims following the specific embodiments are thus explicitly incorporated into the specific embodiments, where each claim itself serves as a separate embodiment of the present disclosure.

Those skilled in the art can understand all features, other than those mutually exclusive, disclosed in this specification (including the accompanying claims, abstract, and drawings) and all processes or units of any method or device disclosed can be employed in any combination. Unless expressly stated otherwise, each feature disclosed in this specification (including the accompanying claims, abstract, and drawings) may be replaced by an alternative feature providing the same, equivalent, or similar purpose.

In addition, those skilled in the art can understand that although some embodiments described herein include certain features included in other embodiments rather than other features, the combination of features of different embodiments means that they are within the scope of the present disclosure and form different embodiments. For example, in the claims, any one of the claimed embodiments can be used in any combination.

The various component embodiments of the present disclosure may be implemented by hardware, or by software module running on one or more processors, or by a combination thereof. Those skilled in the art should understand that a microprocessor or a digital signal processor (DSP) may be used in practice to implement some or all of the functions of some modules according to the embodiments of the present disclosure. The present disclosure can also be implemented as a device program (for example, a computer program and a computer program product) for executing part or all of the methods described herein. Such a program implementing the present disclosure may be stored on a computer-readable medium, or may have the form of one or more signals. Such signals can be downloaded from an Internet website, or provided in carrier signals, or provided in any other form.

It should be noted that the embodiments described above illustrate rather than limit the present disclosure, and those skilled in the art can design alternative embodiments without departing from the scope of the appended claims. In the claims, any reference symbols placed between parentheses shall not be constructed as a limitation to the claims. The present disclosure can be implemented by means of hardware including several different elements and by means of a suitably programmed computer. In the unit claims listing several devices, several of these devices may be embodied in the same hardware item. The use of the words first, second, and third, etc. do not indicate any order. These words can be interpreted as names.

What is claimed is:

1. A side-rearview mirror comprising:
a housing with a cavity; and
a sensor including a LIDAR accommodated in the cavity and configured to detect environment information of one side of a vehicle;
wherein one side of the side-rearview mirror facing a side-rear direction of the vehicle includes a non-mirror surface.

2. The side-rearview mirror of claim 1, wherein the sensor further includes a vision sensor configured to obtain an environment image of the one side of the vehicle.

3. The side-rearview mirror of claim 1, wherein the LIDAR includes a first LIDAR and a second LIDAR integrated within the housing, field of view angles of the first LIDAR and the second LIDAR at least partially overlapping.

4. The side-rearview mirror of claim 3, wherein an overlap range of the field of view angles of the first LIDAR and the second LIDAR is less than 10°.

5. The side-rearview mirror of claim 3, wherein a combined field of view angle of the first LIDAR and the second LIDAR is greater than or equal to 155°.

6. The side-rearview mirror of claim 3, wherein the first LIDAR and the second LIDAR are arranged such that optical axes of the first LIDAR and the second LIDAR are perpendicular to each other.

7. The side-rearview mirror of claim 3, wherein the field of view angle of the first LIDAR is greater than or equal to 80°, and/or the field of view angle of the second LIDAR is greater than or equal to 80°.

8. The side-rearview mirror of claim 3, wherein a boundary of the field of view angle of one of the first LIDAR and the second LIDAR is parallel to an extension direction of a body of the vehicle.

9. The side-rearview mirror of claim 2, wherein the housing is further provided with a window configured to reveal the LIDAR and the vision sensor.

10. The side-rearview mirror of claim 9, wherein the window is further provided with a sealing structure configured to seal a gap between:
a middle frame of the housing, and
the LIDAR and the vision sensor and a housing middle frame.

11. The side-rearview mirror of claim 1, wherein the housing includes a housing upper cover, a housing lower cover, and a housing middle frame arranged at an edge position between the housing upper cover and the housing lower cover, the housing upper cover, the housing lower cover, and the housing middle frame enclose to form the cavity.

12. The side-rearview mirror of claim 11, wherein a support structure for supporting the LIDAR is provided at the housing lower cover, the support structure including a flat plate part located at the housing lower cover and a connection plate configured to be connected with the vehicle, and a reinforcement structure being provided at the connection plate.

13. The side-rearview mirror of claim 12, wherein the reinforcement structure includes a rib plate, two side surfaces of the rib plate being connected to the flat plate part and the connection plate, respectively.

14. The side-rearview mirror of claim 12, wherein the reinforcement structure is arranged at a side wall of the connection plate proximal to the cavity, and/or the reinforcement structure is arranged at side walls of the connection plate at upper and lower ends of the flat plate part.

15. The side-rearview mirror of claim 12, wherein a heat dissipation structure is provided at an outer surface of the housing middle frame and/or a surface of the support structure close to the housing lower cover for heat dissipation and cooling of the sensor.

16. The side-rearview mirror of claim 15, wherein the heat dissipation structure includes a heat sink and/or a fan.

17. The side-rearview mirror of claim 12, further comprising:
a LIDAR base configured to fix and mount the LIDAR, the LIDAR base being fixed at the support structure.

18. The side-rearview mirror of claim 1, wherein the side-rearview mirror is configured to be mounted at the vehicle as a whole through a fixation structure.

19. The side-rearview mirror of claim 18, wherein the fixation structure includes a first surface and a second surface arranged oppositely, the first surface being configured to be fixedly mounted at the vehicle, and the second surface being configured to mount the housing.

20. The side-rearview mirror of claim 19, wherein the first surface of the fixation structure is provided with a fixation connection member configured to connect to a matching fixation connection member at the vehicle.
